(19) United States
(12) Patent Application Publication
(10) Pub. No.: US 2005/0146215 A1
(43) Pub. Date: Jul. 7, 2005

(54) Motor vehicle locking system

(75) Inventors: Checrallah Kachouh, Dortmund (DE); Markus Kothe, Velbert (DE); Rainer Pollmann, Isen (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH & Co. KG, Wuppertal (DE)

(21) Appl. No.: 11/006,829

(22) Filed: Dec. 8, 2004

(30) Foreign Application Priority Data
Dec. 9, 2003 (DE) 103 57 947.8

(51) Int. Cl. B60L 3/00

(52) U.S. Cl. 307/10.1

(57) ABSTRACT

A motor vehicle lock with an electrically openable motor vehicle lock and a child safety is proposed. A very simple and economical structure is enabled in that the opening mechanism, which can be manually actuated from the inside, can be blocked exclusively by manual actuation and the child safety can be overridden and re-enabled electrically without mechanical mechanisms. Here, a version is especially interesting in which the electrically operating child safety is temporarily deactivated (overridden) so that then, during the time interval of deactivation, the motor vehicle can be electrically opened in spite of a manually activated child safety.

### BACKGROUND OF THE INVENTION

1. Field of Invention

This invention relates to a motor vehicle locking system for a motor vehicle with a motor vehicle lock which can be electrically opened, with an inside actuating element and with a child safety which, when enabled or in the on state, prevents electrical opening of the motor vehicle lock by actuating the inside actuating element.

2. Description of Related Art

German Patent DE 100 01 415 C1 and corresponding published U.S. patent application 2001/0022549 A1, form the starting point of this invention and disclose a motor vehicle locking system with a motor vehicle lock which can be opened by an electric motor, and an electrically operating child safety.

To date, a manually actuated opening mechanism has been assigned to any electrically openable motor vehicle lock for reasons of safety and redundancy, so that the motor vehicle lock fundamentally remains mechanically openable from the inside when the electrical system fails. For purposes of child safety, this opening mechanism can be blocked by an electric motor. The electromotive blocking, however, is complex, since a motor, gearing, and optionally additional levers are necessary.

### SUMMARY OF THE INVENTION

The expression “motor vehicle lock” in this application is primarily a side door lock of a motor vehicle. However, it can also be a tailgate lock, a hood lock, or a hatch lock of a motor vehicle.

The expression “child safety” in this application refers to selective blocking of the inside opening of a motor vehicle lock, and thus, of the assigned motor vehicle door, especially for protection of children against unwanted or unintentional opening.

A primary object of this invention is to devise a motor vehicle locking system in which comfortable child safety is enabled with a simple and economical structure.

The aforementioned object is achieved by a motor vehicle locking system in accordance with the invention by the opening mechanism which is connected to the motor vehicle lock being manually activated from the passenger compartment of the motor vehicle, and being manually blocked by the child safety which otherwise can be electrically enabled and disabled.

The underlying idea of this invention is to assign to a motor vehicle lock an opening mechanism which can be manually actuated from the inside and which can be blocked by the child safety that is exclusively manually actuated, and the child safety otherwise can be electrically overridden and re-enabled, so that it operates, in this respect, exclusively electrically and free of mechanisms. The term “blocked” and the expression “can be blocked” for the purposes of the teaching of this invention should be understood as a functional description. Structurally, this can be accomplished by mechanical blocking such that the opening mechanism which can be manually actuated from the inside, aside from the tolerances and inherent elasticities of the power transmission train, can no longer be moved. Implementation of a free-wheel drive mechanism is more common so that the manually actuated opening mechanism in the “child-safe” position executes simply an idle stroke and remains inactive.

One alternative idea of this invention is to make the motor vehicle lock electrically openable from the inside, and the child safety can be selectively turned on and off continuously by means of a switch which is especially accessible to the driver.

Preferably, the child safety, in the on state, can be temporarily deactivated so that, for the duration of such a deactivation, in spite of the child safety being on, a passenger can open the motor vehicle door, which has actually been made child-safe, by actuating the inside actuating element without it being necessary to open the motor vehicle door from the outside.

Other advantages, features, properties and aspects of this invention derive from the following description of preferred embodiments with reference to the accompanying drawings.

### BRIEF DESCRIPTION OF THE DRAWINGS

FIG. 1 is a schematic perspective of a motor vehicle with a motor vehicle locking system in accordance with the invention with several motor vehicle locks;

FIG. 2 is a schematic representation of the motor vehicle locking system of the invention according to a first embodiment; and

FIG. 3 is a schematic representation of a motor vehicle locking system according to a second embodiment of the invention.

### DETAILED DESCRIPTION OF THE INVENTION

In the figures, the same reference numbers are used for the same or similar parts, the corresponding or comparable properties and advantages being achieved even if a repeated description is omitted.

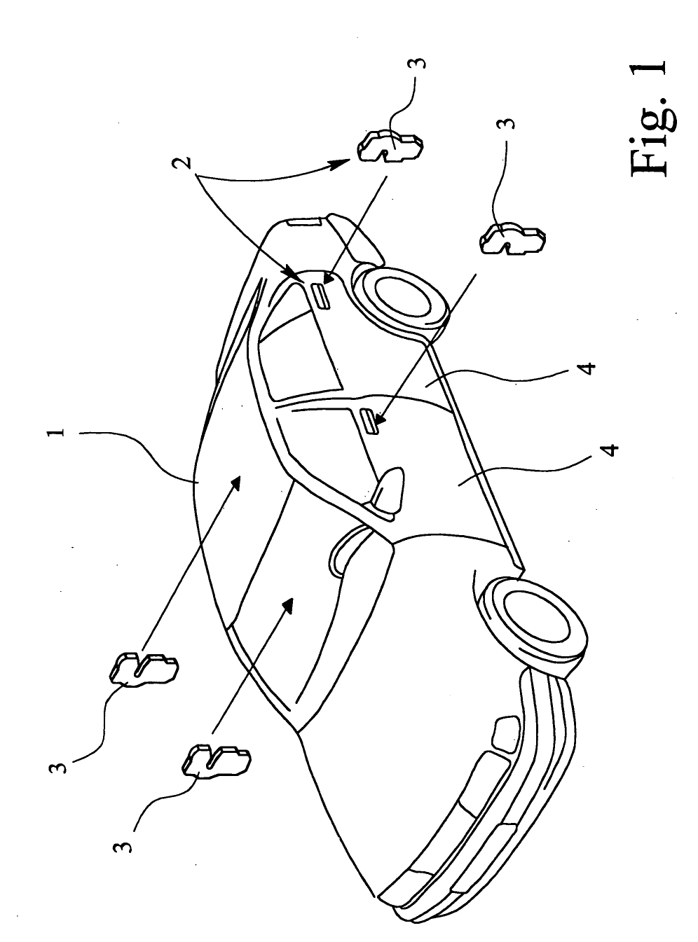

FIG. 1 shows a motor vehicle 1 with a motor vehicle locking system 2 in accordance with the invention with, preferably, several motor vehicle locks 3, especially side door locks for side doors 4. The arrows in FIG. 1 indicate the approximate installation positions of the illustrated motor vehicle locks 3 in the motor vehicle 1.

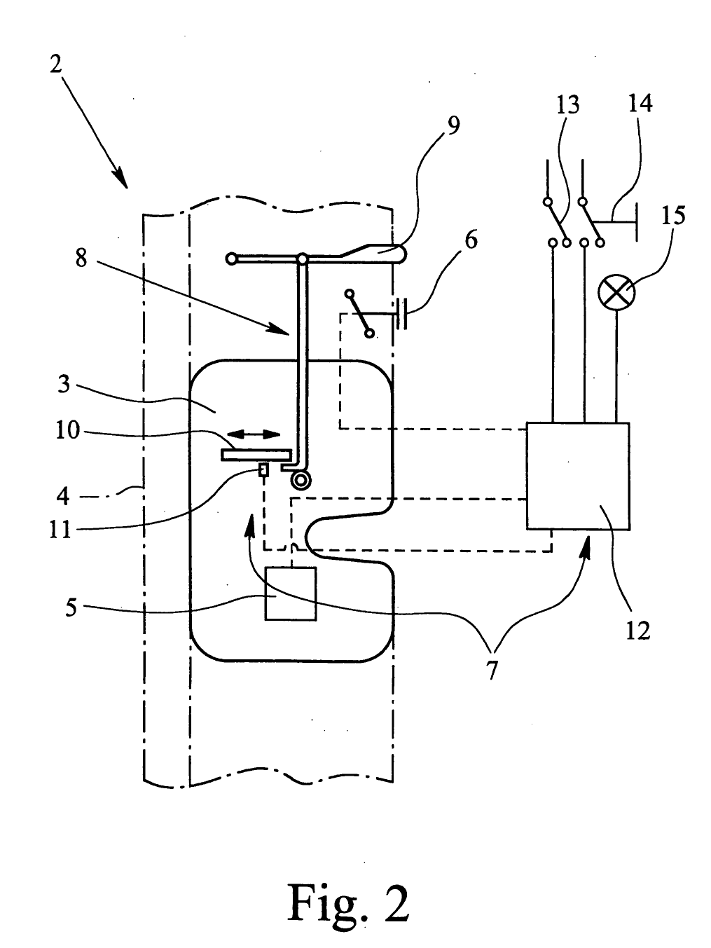

Each motor vehicle lock 3 can be opened preferably by a motor, especially an electric motor, in an execution as a so-called electric lock. For example, the drive 5 which is indicated in FIG. 2, such as an electric motor, for opening, can lift a ratchet (not shown) and which, in the closed state, for example, can block a latch (not shown). However, the motor vehicle locks 3 can also be driven by a motor in some other way or can be opened, for example, pneumatically. Preferably, opening can be electrically controlled.

FIG. 2 schematically shows a first embodiment of the motor vehicle locking system 2 of the invention, specifically a motor vehicle lock 3 on an assigned motor vehicle door 4.

The motor vehicle locking system 2 has an inside actuating element 6 which can be actuated by an operator (not shown) in the interior or passenger compartment of the motor vehicle 1 in order to open the assigned motor vehicle lock 3 by means of a drive 5. The inside actuating element 6 is accordingly assigned especially to the respective motor vehicle door 4, preferably on its inside.

The inside actuating element 6 enables electrically controlled opening of the motor vehicle lock 3. Preferably, the inside actuating element 6 is made as an electrical pushbutton, double throw momentary contact switch, microswitch or other sensor, or is provided with them. Instead of manual actuation of the inside actuating element 6, optionally, also touching or even approaching can suffice. The inside actuating element 6 or the components assigned to it, in the normal state, upon actuation, lead to electrically controlled opening of the assigned motor vehicle lock 3 by means of the drive 5.

Furthermore, the motor vehicle locking system 2 has a child safety 7 which, in the enabled or on state, results in that the motor vehicle lock 3, and thus, the motor vehicle 4, cannot be opened from the inside. This will be explained in detail below.

In the first embodiment, the motor vehicle locking system 2 has an opening mechanism 8 which can be manually actuated from the inside and which is provided, especially for reasons of safety and redundancy, so that the motor vehicle lock 3 fundamentally remains mechanically openable from the inside when the electrical system fails. The opening mechanism 8 allows especially mechanical lifting of a ratchet (not shown) in the motor vehicle lock 3.

The opening mechanism 8 can be actuated manually from the inside, for example, by means of the inside actuating element 6, or—as indicated in FIG. 2—by means of a separate inside actuating lever 9, an ordinary handle or the like.

The opening mechanism 8—especially only when the motor vehicle 4 has been opened—can be blocked, especially by a catch lever 10 or the like. In the blocked state, consequently, the motor vehicle lock 3 can no longer be mechanically opened from the inside. In this respect, the concept of blocked or able to be blocked should be understood functionally. Structurally, as shown, this can be implemented by mechanical blocking so that the inside actuating lever 9 can no longer be moved. However, a free-wheel drive mechanism is equally possible, often preferred, so that the inside actuating lever 9 executes an idle stroke in the “child-safe” position.

Accordingly the child safety 7 comprises the catch lever 10 which can be actuated exclusively manually or some other blocking mechanism (or idle stroke mechanism) which can only be manually actuated. The blocking of the opening mechanism 8, therefore, does not take place by a motor, as is otherwise conventional in the prior art, but only by manual actuation. In this way, a drive is saved.

Preferably, a microswitch 1 or other sensor is assigned to the catch lever 10 so that manual activation of blocking of the opening mechanism 8 can be detected.

The motor vehicle locking system 2 here, preferably, has a central or decentralized control means 12 which also optionally comprises several modules or components. The inside actuating element 6 and the microswitch 11 or other sensor are connected to the control means 12.

When the inside actuating element 6 is actuated, an opening signal is generated and detected and is relayed or output then by the control means 12 as the driving or opening signal to the motor vehicle lock 3 or its drive 5 when the child safety function is turned off or deactivated or disabled. The control means 12 accordingly constitutes the part of the child safety 7 which operates exclusively electrically and without mechanisms.

When the child safety 7 has been turned on or enabled, the control means 12 does not output an opening or driving signal to the motor vehicle lock 3 or its drive 5, even if the inside actuating element 6 is actuated by a passenger.

The indicated, electrically operating child safety function is preferably turned on automatically when blocking of the opening mechanism 8 by manual actuation has been detected by the microswitch 11 or other sensor. Accordingly, the child safety 7 or the electrically operating child safety function can be turned off again automatically when cancellation of manual blocking of the opening mechanism 8 is detected.

Alternatively or in addition, the electrically operated child safety function can be selectively turned off or on (overridden or re-enabled) by means of a switch 13 which is accessible especially to the driver and/or front-seat passenger who is not shown.

According to one especially preferred embodiment, the electrically operating child safety function can be temporarily deactivated (overridden), especially by means of a switch, button 14 or the like, which is accessible especially to the driver and/or a front-seat passenger so that, for the duration of this deactivation—therefore especially while the switch 13 is in the position which turns on the child safety function—the motor vehicle lock 3 is electrically opened when the inside actuating element 6 is actuated.

The child safety function therefore is or can be temporarily disabled (overridden) only electrically. This is advantageous, for example, when the driver intends to allow a passenger to get out through the vehicle door 4 which fundamentally cannot be opened from the inside due to the child safety function. Opening of the motor vehicle lock 3 from the outside in the approach of the invention is possible, but not necessary; rather, in this case, a passenger can open the motor vehicle lock 3 from the inside and can get out of the vehicle 1.

Temporary deactivation takes place preferably only for a predetermined, especially predefinable time interval, only during activation of the button 14 and/or only for one-time opening of the motor vehicle lock 3.

The button 14 is made especially as a pushbutton so that preferably only temporary deactivation (overriding) of the child safety 7—therefore, the electrically operating child safety function—is possible at all. In this way, the child safety function can be prevented from being permanently deactivated unintentionally.

Preferably, the (temporary) deactivation of the child safety function—especially by means of the button 14—can take place selectively for the back right or left side door 4, for both back doors and/or for the front passenger door 4.

In addition, when the child safety 7 is on, deactivation is preferably displayed, especially by means of a light 15 or other indicator which is preferably easily visible to the driver.

It should be noted that triggering, signal generation and processing ordinarily each take place electrically or electronically. For reasons of simplification, in this invention, electrical and electronic are not distinguished from one another. The term “electrical” should rather also comprise electronic control, evaluation, processing, signal generation and the like, or control, evaluation, processing, signal generation and the like which takes place by software.

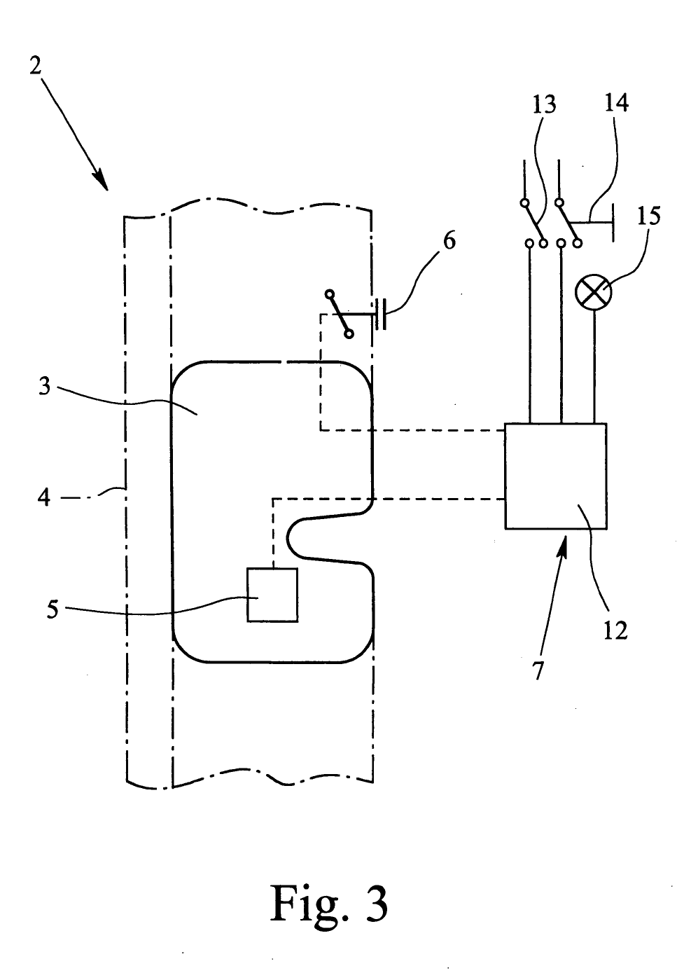

A second embodiment of the motor vehicle locking system 2 in accordance with the invention is explained below using FIG. 3. Here, only essential differences between the second embodiment and the first embodiment are emphasized. Otherwise, at least essentially corresponding or comparable properties and advantages arise.

In the second embodiment, there is not any opening mechanism 8. The motor vehicle lock 3 therefore cannot, in general, be opened mechanically from the inside. This enables an especially simple and thus economical structure.

Complete elimination of the mechanical opening capacity of the motor vehicle lock 3 from the inside, which is otherwise provided for reasons of safety and redundancy, can therefore be supported because for a mechanically acting child safety, the case can occur anyway that the motor vehicle lock 3 cannot be mechanically opened. Accordingly, the child safety 7 in the second embodiment works exclusively electrically—therefore, without moving parts and without mechanisms. This allows further simplification of the structure. In the second embodiment, a switch 13 is necessary for selective stable manual turning on and off of the child safety 7.

Instead of the switch 13, in the two embodiments, turning on and off can also be controlled in some other way, especially by the driver, for example, by a software-based control function or the like which implements the function of the switch.

The motor vehicle locking system 2 of the invention can be used preferably for the back doors 4 of a motor vehicle 1, a tailgate door and/or for the front passenger door 4.

1. Motor vehicle locking system for a motor vehicle, comprising:
an electrically openable motor vehicle lock,
an inside actuating element,
a child safety which, when enabled or in an on state, prevents electrical opening of the motor vehicle lock by actuation of the inside actuating element, and
a manually actuatable opening mechanism which is accessible in the passenger compartment of the motor vehicle and which is connected to the motor vehicle lock,
wherein the child safety is adapted to be only manually actuated for blocking of the opening mechanism, and when the child safety is manually activated, the vehicle lock, from the passenger compartment, is only able to be opened electrically, and wherein the child safety is also able to be overridden and re-enabled electrically.

2. Motor vehicle locking system as claimed in claim 1, wherein the opening mechanism is actuatable by at least one of the inside actuating element and an additional, mechanically acting inside actuating lever.

3. Motor vehicle locking system as claimed in claim 1, wherein manual blocking of the opening mechanism is detectable by a sensor.

4. Motor vehicle locking system as claimed in claim 1, wherein manual blocking of the opening mechanism is detectable by a microswitch sensor.

5. Motor vehicle locking system as claimed in claim 3, wherein, when the opening mechanism is manually blocked, the electrically operating child safety is automatically enabled or turned on, and when the manual blocking is cancelled, the child safety is automatically disabled.

6. Motor vehicle locking system as claimed in claim 4, wherein, when the opening mechanism is manually blocked, the electrically operating child safety is automatically enabled or turned on, and when the manual blocking is cancelled, the child safety is automatically disabled.

7. Motor vehicle locking system as claimed in claim 5, wherein the electrically operating child safety is adapted to be selectively turned on or off by means of a switch which is actuatable by at least one of a driver and a front-seat passenger of the motor vehicle.

8. Motor vehicle locking system as claimed in claim 1, wherein the electrically operating child safety is adapted to be selectively turned on or off by means of a switch which is actuatable by at least one of a driver and a front-seat passenger of the motor vehicle.

9. Motor vehicle locking system as claimed in claim 1, wherein the electrically operating child safety is adapted to be deactivated by short term or ongoing actuation of a button during activation of the button, the button being actuatable by at least one of a driver and a front-seat passenger of the motor vehicle, and when the child safety is deactivated, the motor vehicle lock is electrically openable by actuation of the inside actuating element.

10. Motor vehicle locking system as claimed in claim 9, wherein, selectively, the motor vehicle lock is releasable for only the right or left back door, for both the right and left back door, and for the front passenger door by deactivation of the child safety to enable opening thereof when the inside actuating element is actuated.

11. Motor vehicle locking system as claimed in claim 1, wherein the electrically operating child safety is adapted to be deactivated during a predetermined time interval by short term or ongoing actuation of a button, the button being actuatable by at least one of a driver and a front-seat passenger of the motor vehicle, and when the child safety is deactivated, the motor vehicle lock is electrically openable by actuation of the inside actuating element.

12. Motor vehicle locking system as claimed in claim 11, wherein, selectively, the motor vehicle lock is releasable for only the right or left back door, for both the right and left back door, and for the front passenger door by deactivation of the child safety to enable opening thereof when the inside actuating element is actuated.

13. Motor vehicle locking system as claimed in claim 1, wherein the electrically operating child safety is adapted to be deactivated for one-time opening by short term or ongoing actuation of a button, the button being actuatable by at least one of a driver and a front-seat passenger of the motor vehicle, and when the child safety is deactivated, the motor vehicle lock is electrically openable by actuation of the inside actuating element.

14. Motor vehicle locking system as claimed in claim 13, wherein, selectively, the motor vehicle lock is releasable for only the right or left back door, for both the right and left back door, and for the front passenger door by deactivation of the child safety to enable opening thereof when the inside actuating element is actuated.

15. Motor vehicle locking system as claimed in claim 5, wherein the electrically operating child safety is adapted to be deactivated by short term or ongoing actuation of a button during activation of the button, the button being actuatable by at least one of a driver and a front-seat passenger of the motor vehicle, and when the child safety is deactivated, the motor vehicle lock is electrically openable by actuation of the inside actuating element.

16. Motor vehicle locking system as claimed in claim 15, wherein, selectively, the motor vehicle lock is releasable for only the right or left back door, for both the right and left back door, and for the front passenger door by deactivation of the child safety to enable opening thereof when the inside actuating element is actuated.

17. Motor vehicle locking system as claimed in claim 5, wherein the electrically operating child safety is adapted to be deactivated during a predetermined time interval by short term or ongoing actuation of a button, the button being actuatable by at least one of a driver and a front-seat passenger of the motor vehicle, and when the child safety is deactivated, the motor vehicle lock is electrically openable by actuation of the inside actuating element.

18. Motor vehicle locking system as claimed in claim 17, wherein, selectively, the motor vehicle lock is releasable for only the right or left back door, for both the right and left back door, and for the front passenger door by deactivation of the child safety to enable opening thereof when the inside actuating element is actuated.

19. Motor vehicle locking system as claimed in claim 5, wherein the electrically operating child safety is adapted to be deactivated for one-time opening by short term or ongoing actuation of a button, the button being actuatable by at least one of a driver and a front-seat passenger of the motor vehicle, and when the child safety is deactivated, the motor vehicle lock is electrically openable by actuation of the inside actuating element.

20. Motor vehicle locking system as claimed in claim 19, wherein, selectively, the motor vehicle lock is releasable for only the right or left back door, for both the right and left back door, and for the front passenger door by deactivation of the child safety to enable opening thereof when the inside actuating element is actuated.

21. Motor vehicle locking system as claimed in claim 1, wherein electrical deactivation of the child safety is indicated by at least one of optical and acoustic means.

22. Motor vehicle locking system for a motor vehicle, comprising:
an electrically openable motor vehicle lock,
an inside actuating element, and
a child safety which, when enabled or in an on state, prevents electrical opening of the motor vehicle lock by actuation of the inside actuating element,
wherein the motor vehicle lock is electrically openable from the passenger compartment of the motor vehicle, and
wherein the child safety is adapted to be electrically enabled and disabled by means of a switch which is manually actuatable by at least one of a driver and a front-seat passenger of the motor vehicle.

23. Motor vehicle locking system as claimed in claim 22, wherein the child safety works exclusively electrically without mechanical mechanisms.

24. Motor vehicle locking system as claimed in claim 22, wherein the child safety is adapted to be deactivated by short term or ongoing actuation of a button during activation of the button, the button being actuatable by at least one of a driver and a front-seat passenger of the motor vehicle, and when the child safety is deactivated, the motor vehicle lock is electrically openable by actuation of the inside actuating element.

25. Motor vehicle locking system as claimed in claim 24, wherein, selectively, the motor vehicle lock is releasable for only the right or left back door, for both the right and left back door, and for the front passenger door by deactivation of the child safety to enable opening thereof when the inside actuating element is actuated.

26. Motor vehicle locking system as claimed in claim 22, wherein the child safety is adapted to be deactivated during a predetermined time intervall by short term or ongoing actuation of a button, the button being actuatable by at least one of a driver and a front-seat passenger of the motor vehicle, and when the child safety is deactivated, the motor vehicle lock is electrically openable by actuation of the inside actuating element.

27. Motor vehicle locking system as claimed in claim 26, wherein, selectively, the motor vehicle lock is releasable for only the right or left back door, for both the right and left back door, and for the front passenger door by deactivation of the child safety to enable opening thereof when the inside actuating element is actuated.

28. Motor vehicle locking system as claimed in claim 22, wherein the child safety is adapted to be deactivated for one-time opening by short term or ongoing actuation of a button, the button being actuatable by at least one of a driver and a front-seat passenger of the motor vehicle, and when the child safety is deactivated, the motor vehicle lock is electrically openable by actuation of the inside actuating element.

29. Motor vehicle locking system as claimed in claim 28, wherein, selectively, the motor vehicle lock is releasable for only the right or left back door, for both the right and left back door, and for the front passenger door by deactivation of the child safety to enable opening thereof when the inside actuating element is actuated.

30. Motor vehicle locking system as claimed in claim 22, wherein electrical deactivation of the child safety is indicated by at least one of optical and acoustic means.
